(19) United States
(12) Patent Application Publication
(10) Pub. No.: US 2007/0289424 A1
(43) Pub. Date: Dec. 20, 2007

(54) Workpiece-holding device for band saw machine

(75) Inventor: Long-Chang Jan, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: OAV Equipment & Tools, Inc., Taichung Hsien (TW)

(21) Appl. No.: 11/455,656

(22) Filed: Jun. 20, 2006

(51) Int. Cl. B26D 7/02

(52) U.S. Cl. 83/452; 83/788

(57) ABSTRACT

A workpiece-holding device for holding a workpiece on a worktable of a band saw machine having a vertically moveable saw blade guide and a saw blade running through the worktable and the vertically moveable saw blade guide is disclosed. The workpiece-holding device includes a suspension arm for horizontally and axially moveably mounting to the vertically moveable saw blade guide of the band saw machine, an offset member having an end horizontally and perpendicularly connected to the suspension arm, and a holding pin vertically and perpendicularly connected to the other end of the offset member for stopping at a workpiece on the worktable such that the workpiece is rotatable about the holding pin on the worktable for enabling the workpiece to be cut into an arched or circular shape by the saw blade.

### BACKGROUND OF THE INVENTION

1. Field of the Invention

The present invention relates to an accessory for use in a band saw machine and more specifically, to a workpiece-holding device for use in a band saw machine for holding a workpiece on a worktable of the band saw machine in a manner that enables the workpiece to be cut into an arched or circular shape by a saw blade of the band saw machine.

2. Description of the Related Art

A conventional band saw machine generally comprises a base having a worktable, and a saw blade run through the worktable of the base. The worktable of the band saw machine is adapted to hold a workpiece for cutting by the saw blade. When the operator puts a workpiece on the worktable and then moves the workpiece to touch the running saw blade, the workpiece is cut by the saw blade.

According to the aforesaid conventional design, a workpiece can be but by the saw blade only along a straight line. If the operator wishes to cut a workpiece into an arched or circular shape, other processing machine shall be used. Therefore, the aforesaid conventional band saw machine provides a limited function, causing great inconvenient to the operator.

### SUMMARY OF THE INVENTION

The present invention has been accomplished under the circumstances in view. It is one objective of the present invention to provide a workpiece-holding device for use in a band saw machine for holding a workpiece on the worktable of the band saw machine for allowing the operator to rotate the workpiece so that the workpiece can be cut by the saw blade of the band saw machine into an arched or circular shape conveniently.

To achieve this objective of the present invention, the workpiece-holding device is used in a band saw machine for holding a workpiece on a worktable of the band saw machine having a vertically moveable saw blade guide and a saw blade running through the worktable and the vertically moveable saw blade guide. The workpiece-holding device comprises a suspension arm for horizontally and axially moveably mounting to the vertically moveable saw blade guide of the band saw machine, an offset member having an end horizontally and perpendicularly connected to the suspension arm, and a holding pin vertically and perpendicularly connected to the other end of the offset member for stopping at a workpiece on the worktable such that the workpiece is rotatable about the holding pin on the worktable for enabling the workpiece to be cut into an arched or circular shape by the saw blade.

In a preferred embodiment of the present invention, the end of the offset member is provided with a horizontally elongated slot in which an end of the suspension arm is detachably positioned. The end of the suspension is adjustably fixed at a desired position of the horizontally elongated slot by a crew.

In the preferred embodiment, the other end of the offset member has a through hole into which the holding pin is inserted. The holding pin is fixedly connected to the offset member by a screw.

### BRIEF DESCRIPTION OF THE DRAWINGS

The forgoing features and advantages of the invention will be readily understood by reference to the following more particular description of the preferred embodiment of the invention and the accompanying drawings wherein:

FIG. 1 is a perspective view showing a workpiece-holding device in accordance with a preferred embodiment of the present invention installed in a band saw machine;

FIG. 2 is an exploded view of the workpiece-holding device shown in FIG. 1; and

FIG. 3 is a schematic drawing showing an application example of the workpiece-holding device cooperated with the band saw machine.

### DETAILED DESCRIPTION OF THE INVENTION

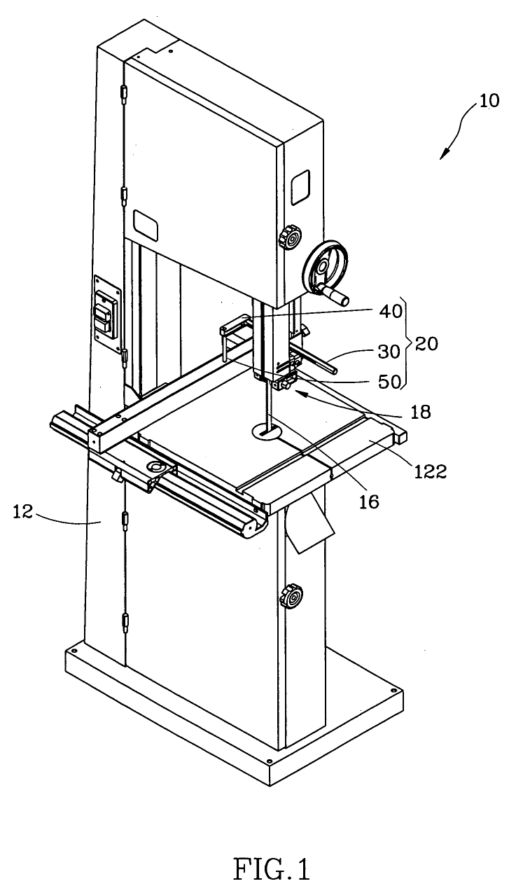

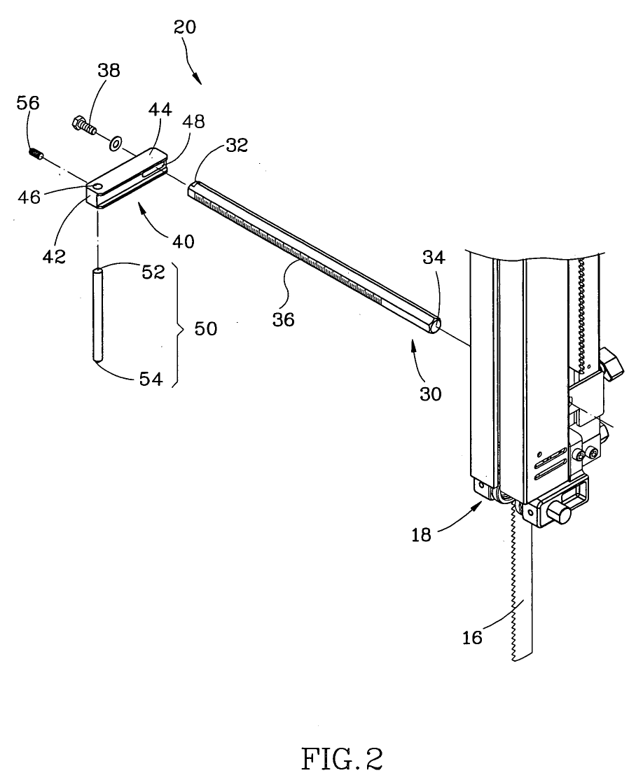

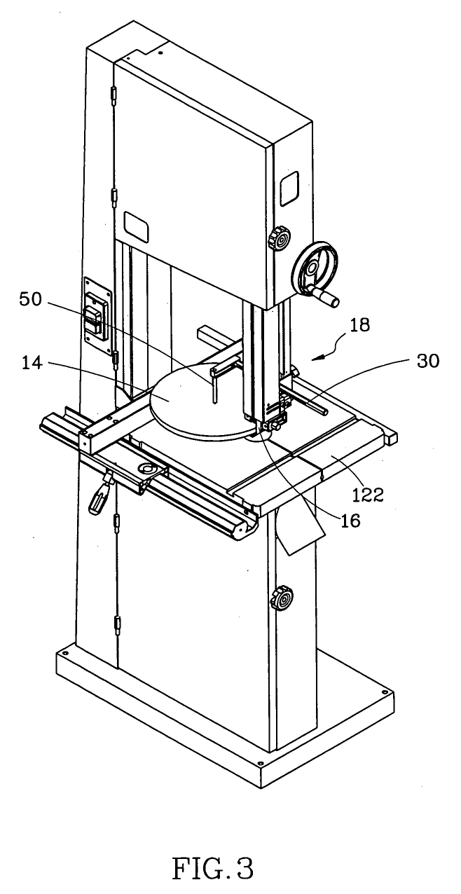

As shown in FIGS. 1 and 2, a workpiece-holding device 20 in accordance with a preferred embodiment of the present invention is installed in a band saw machine 10. The band saw machine 10 comprises a base 12. The base 12 has a worktable 122 at the top side to support a workpiece 14 for cutting, as shown in FIG. 3. The band saw machine 10 further comprises a saw blade 16 and a vertically moveably saw blade guide 18. The saw blade 16 extends over a transmission wheel (not shown) and runs through the worktable 122 and the saw blade guide 18 and is rotatable by the transmission wheel to cut the workpiece 14. The saw blade guide 18 is mounted around the saw blade 16, and movable vertically by a drive gear (not shown) relative to the saw blade 16 to guide and guard the saw blade 16, thereby making the saw blade 16 be smoothly running and preventing the operator from touching the saw blade 16 accidentally. The workpiece-holding device 20 comprises a suspension arm 30, an offset member 40, and a holding pin 20.

The suspension arm 30 is a metal member slidably inserted through a part of the saw blade guide 18, which offsets a predetermined distance from the saw blade 16, such that the suspension arm 30 is vertically movable along with the saw blade guide 18 relative to the worktable 122. Further, the suspension arm 30 is slidably coupled to the saw blade guide 18 in horizontal, i.e. in parallel to the worktable 122, such that the suspension arm 30 is axially movable relative to the saw blade guide 18. The suspension arm 30 has a front end 32, a rear end 34, and graduations 36 marked on the periphery between the front end 32 and the rear end 34.

The offset member 40 is a metal member having a length about equal to the distance between the suspension arm 30 and the saw blade 16. The offset member 40 has a front end 42 having a through hole 46 and a rear end 44 having a horizontally elongated slot 48. The rear end 44 of the offset member 40 is perpendicularly connectable to the front end 32 or rear end 34 of the suspension arm 30 with a screw 38 so that the offset member 40 is kept perpendicular to the suspension arm 30 and in parallel to the worktable 122. According to the present preferred embodiment, the front end 32 of the suspension arm 30 is adjustably positioned in the horizontally elongated slot 48 at a desired position by the screw 38 such that the rear end 44 of the offset member 40 is perpendicularly connected to the front end 32 of the suspension arm 30.

The holding pin 50 is a metal pin having a top end 52 and a bottom end 54. The top end 52 is slidably inserted into the through hole 46 of the offset member 40 and fixedly positioned in the through hole 46 by a screw 56 so that the bottom end 54 can vertically extend downwards and press on the workpiece 14. Further, the distance between the bottom end 54 of the holding pin 50 and the saw blade 16 is approximately equal to the radius of the workpiece 14 after cutting.

Referring to FIG. 3 again, after the operator placed the workpiece 14 on the worktable 122, the operator can move the suspension arm 30 to the desired position. By means of the graduations 36 of the suspension arm 30, the operator can accurately adjust the distance between the holding pin 50 and the saw blade 16, i.e. adjust the radius of the workpiece 14 after cutting. Thereafter, the operator can lower the saw blade guide 18 to have the holding pin 50 pressed on the workpiece 14. At this time, the operator can start running the saw blade 16 and move the workpiece 14 to rotate about the holding pin 50, enabling the workpiece 14 to be cut by the saw blade 16 into an arched or circular shape.

As indicated above, the workpiece-holding device 20 of the present invention has a simple structure that allows the user to cut the workpiece 14 into an arched or circular shape of any of a series of radius conveniently as desired.

What is claimed is:

1. A workpiece-holding device for holding a workpiece on a worktable of a band saw machine having a vertically moveable saw blade guide and a saw blade running through the worktable and the vertically moveable saw blade guide for enabling the workpiece to be cut into an arched or circular shape by the saw blade, the workpiece-holding device comprising:
a suspension arm for horizontally and axially moveably mounting to the vertically moveable saw blade guide of the band saw machine;
an offset member having an end horizontally and perpendicularly connected to the suspension arm; and
a holding pin vertically and perpendicularly connected to the other end of the offset member for stopping at a workpiece on the worktable such that the workpiece is rotatable about the holding pin on the worktable for cutting by the saw blade.

2. The workpiece-holding device as claimed in claim 1, wherein the end of the offset member, which is connected to the suspension arm, has a horizontally elongated slot in which an end of the suspension arm is detachably positioned.

3. The workpiece-holding device as claimed in claim 2, wherein the end of the suspension arm is fixedly connected to the offset member by a screw.

4. The workpiece-holding device as claimed in claim 1, wherein the other end of the offset member has a through hole into which the holding pin is inserted.

5. The workpiece-holding device as claimed in claim 4, wherein the holding pin is fixedly connected to the offset member by a screw.

6. The workpiece-holding device as claimed in claim 1, wherein the suspension arm has graduations marked on a periphery thereof.
